(19) United States
(12) Patent Application Publication
(10) Pub. No.: US 2009/0077541 A1
(43) Pub. Date: Mar. 19, 2009

(54) METHOD AND APPARATUS FOR TESTING AND MONITORING SYSTEMS USING RECONFIGURABLE HARDWARE AND SOFTWARE RESOURCES

(76) Inventors: Myron Jeffries, Plano, IL (US); John Knapek, Naperville, IL (US); David M. Smith, Plainfield, IL (US); Mark E. Boduch, Geneva, IL (US); Taqi Mohiuddin, Ladera Ranch, CA (US); Tony Copley, Wheaton, IL (US); Paul Mack, Warrenville, IL (US); Mark Stadalsky, Minooka, IL (US); Roger J. Gale, Batavia, IL (US)

Correspondence Address: WILDFIRE TEST INC., 12407 ANDREW ST, PLANO, IL, 60545-9794, US

(21) Appl. No.: 11/858,107

(22) Filed: Sep. 19, 2007

(51) Int. Cl. G06F 9/44

(52) U.S. Cl. 717/127

(57) ABSTRACT

According to a first embodiment of the present invention, reconfigurable resources within a reconfigurable test unit are configured to test or monitor a first function associated with a system under test. Following the completion of the testing or monitoring of the first function, the reconfigurable resources within the reconfigurable test unit are configured to test or monitor a second function associated with the system under test, wherein the second function may be substantially different than the first function. The method and apparatus so described allows for the testing of systems using a minimal amount of hardware and software resources within a reconfigurable test unit.

### FIELD OF THE INVENTION

This invention relates in general to the field of test, measurement, and monitoring.

### BACKGROUND OF THE INVENTION

Today's complex systems require equally complex test units. A test unit is a device that is used to test some functionality associated with a given system, subsystem, or grouping of systems. As an example, in a communication oriented system, a test unit may be utilized to test a particular communication protocol associated with the system (such as SONET or Ethernet). Typically, a test unit is designed to test all of the functionality associated with a particular subsystem or protocol within a system. If a given protocol or subsystem under test contains N functions, typically a test unit is constructed such that it contains the necessary hardware and software needed to test all N functions. However, often (within a system manufacturing environment, for example) it becomes impractical to test all N functions, and instead a subset M of the N functions is tested (where M<N). Alternatively, a system (under test) may be built which only implements part of a given protocol, and therefore, requires at most M functions to be tested out of N total functions. When a test unit that is capable of testing N functions is only used to test M functions, the hardware and software (within the test unit) associated with N-M functions goes unused. Since, within the test unit, a monetary cost is attached to the hardware and software allocated to the testing of each of function, using a test unit that is capable of testing N functions will inherently cost more than a test unit that is only capable of testing M functions. In the past it has been difficult to identify the particular M functions (of the total N possible functions) required by any given user of a test unit, and therefore, general purpose test units capable of testing all N functions have been produced. The present disclosed invention addresses the problem of producing a cost effective test unit that is able to test any arbitrary M sub-functions (of N total functions) associated with a given protocol, system, group of systems, or subsystem under test.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a diagram of a system under test being tested by a test unit according to prior art.

FIG. 2 is a diagram of a system under test being tested by a reconfigurable test unit according to one embodiment of the present invention.

FIG. 3A is a diagram of a system under test being tested by a reconfigurable test unit wherein Function 1 of the system under test is tested according to one embodiment of the present invention.

FIG. 3B is a diagram of a system under test being tested by a reconfigurable test unit wherein Function 2 of the system under test is tested according to one embodiment of the present invention.

FIG. 3C is a diagram of a system under test being tested by a reconfigurable test unit wherein Function N of the system under test is tested according to one embodiment of the present invention.

FIG. 4A shows a three dimensional view of a reconfigurable hardware circuit pack and two interface specific hardware circuit packs within a reconfigurable test unit according to one embodiment of the present invention.

FIG. 4B shows three circuit packs plugged into a backplane assembly according to one embodiment of the present invention.

FIG. 5 shows the state diagram according to one embodiment of the present invention.

### SUMMARY OF THE INVENTION

A method and apparatus that can be used to test and monitor systems using reconfigurable hardware and software resources is disclosed. According to a first embodiment of the present invention, reconfigurable resources within a reconfigurable test unit are configured to test or monitor a first function associated with a system under test. Following the completion of the testing or monitoring of the first function, the reconfigurable resources within the reconfigurable test unit are configured to test or monitor a second function associated with the system under test, wherein the second function may be substantially different than the first function. The method and apparatus so described allows for the testing of systems using a minimal amount of hardware and software resources within a reconfigurable test unit.

According to a second embodiment of the present invention, reconfigurable hardware and software resources within a reconfigurable test unit are configured to test or monitor a subset (M) of the total functions (N) associated with a given system under test. The subset of M functions tested or monitored can be any M functions within the set of N functions supported by the system under test.

Reconfigurable hardware resources may be implemented using one or more programmable logic devices. A field programmable gate array (or FPGA) is one example of a programmable logic device. (FPGA devices are available from multiple companies, including Xilinx Corporation and Altera Corporation.) Alternatively, or additionally, reconfigurable hardware resources may be implemented with one or more devices containing programmable analog circuitry. In general, reconfigurable hardware resources may be implemented with some number of programmable logic devices and some number of devices containing programmable analog circuitry.

The reconfigurable hardware resources with the reconfigurable test unit are configured by loading a set of hardware configuration data into the reconfigurable hardware resources. The particular set of hardware configuration data that is loaded into the reconfigurable hardware resources determines the functionality of the reconfigurable hardware at any given time. For instance, when a particular first set of hardware configuration data is loaded into the reconfigurable hardware, the hardware may be configured to be a digital shift register, while when a particular second set of hardware configuration data is loaded into the reconfigurable hardware, the hardware may be configured to be a digital counter.

Reconfigurable software resources may be implemented using reconfigurable program memory. Reconfigurable software resources may exist when a test unit contains one or more microprocessors (or similar computer processing engines). Each microprocessor within the test unit may have local reconfigurable program memory associated with it. The local reconfigurable program memory is used to store a set of executable software coding instructions. Local reconfigurable memory can be used to store a first set of executable software coding instructions in order to support the testing or monitoring of a first function or set of functions within a system under test. Following the completion of the testing of the first function or set of functions, the local reconfigurable memory can be used to store a second set of executable software coding instructions in order to support the testing or monitoring of a second function or set of functions within the system under test.

When a test unit contains both reconfigurable hardware and software resources, in order to test or monitor a particular function associated with a system under test a set of hardware configuration data must be loaded into the reconfigurable hardware resources, and a set of executable software coding instructions must be loaded into the reconfigurable software resources. The set of hardware configuration data loaded into the reconfigurable hardware resources is referred to as the hardware test entity for the particular function associated with the system under test. Similarly, the set of executable software coding instructions loaded into the reconfigurable software resources is referred to as the software test entity for the particular function associated with the system under test.

The more generic term “test entity” can be used to refer to any combination of hardware and software test entities. For instance, a “test entity” may have both a hardware component (hardware test entity) and a software component (software test entity) associated with it, or it may only have only a hardware component associated with it, or it may have only a software component associated it.

Therefore, associated with each function or group of functions within the system under test there may be a set of hardware and software test entities. In order to test or monitor a function associated with a system under test, a set of corresponding hardware and software test entities must first be loaded into the hardware and software resources associated with the test unit. The hardware test entities are loaded into the hardware resources and they enable the hardware to test or monitor a specific function or set of functions within the system under test. Similarly, the software test entities are loaded into the software resources and they enable the microprocessor to aid in the testing or monitoring of a specific function or set of functions within the system under test. In most cases, a given microprocessor contains dedicated hardware that can be used to interact with reconfigurable hardware within the test unit. For instance, the microprocessor may contain dedicated hardware consisting of an address bus and a data bus. The address bus and data bus can be used to read and write registers within the reconfigurable hardware, thus allowing the control of the reconfigurable hardware resources via the software coding instructions located in the reconfigurable software resources.

According to a third embodiment of the present invention, a group of hardware and software test entities are stored within the memory resources of a central test entity depository. In order to test or monitor a first function associated with a system under test, the reconfigurable test unit retrieves a first hardware test entity and a first software test entity from the memory resources of the central test entity depository. The hardware entity associated with the first function is then used to reconfigure the hardware resources within the reconfigurable test unit, and the software entity associated with the first function is used to reconfigure the software resources within the reconfigurable test unit. Using the reconfigured hardware and software, a first test or monitoring operation is performed on the system under test. Once the testing or monitoring of the first function is complete, a second function associated with the system under test may be required to be tested or monitored. In order to test or monitor a second function associated with a system under test, the reconfigurable test unit retrieves a second hardware test entity and a second software test entity from the memory resources of the central test entity depository. The hardware entity associated with the second function is then used to reconfigure the hardware resources within the reconfigurable test unit, and the software entity associated with the second function is used to reconfigure the software resources within the reconfigurable test unit. Using the reconfigured hardware and software, a second test or monitoring operation is performed on the system under test. Since the hardware and software resources within the reconfigurable test unit have been reconfigured to perform a second test or monitoring operation, the hardware and software within the reconfigurable test unit may no longer be capable of performing the first test or monitoring operation.

The central test entity depository may be shared by multiple reconfigurable test units. The central test entity depository can be a local server that is reached directly via an Ethernet link, or a remote server that is reached via the Internet.

The method and apparatus so described allows for the testing of systems using a minimal amount of memory and hardware resources within a reconfigurable test unit.

The hardware and software test entities needed to test or monitor a particular function associated with the system under test can be constructed with varying degrees of complexity and functionality. For instance, one test entity could be a simple pattern generator and bit error rate checker, while another test entity could be a test entity that is capable of testing all aspects of a SONET OC-48 signal.

In prior-art test environments, when one wished to test application diverse functions, multiple test boxes would be required (e.g., a SONET test box for SONET applications, an engine diagnostic test box for automotive testing, etc.). According to a fourth embodiment of the present invention, a reconfigurable test unit contains reconfigurable hardware circuit packs and interface specific hardware circuit packs. These circuit packs are capable of plugging into a shared backplane assembly. The shared backplane assembly allows electrical signal information to pass from one circuit pack to another within the reconfigurable test unit. The interface specific hardware circuit pack may provide electrical and or optical interface connections that are specific to the system under test (although the circuit pack is not limited to electrical and optical interface connections). For instance, one type of interface specific hardware circuit pack may contain optical interfaces that are capable of interfacing to a system under test containing SONET OC-48 interfaces, while another interface specific hardware circuit pack may contain electrical interfaces that are capable of interfacing to a system under test containing DS3 interfaces. The various interface specific hardware circuit packs transform the signals received at their interface ports to a common electrical signal format. The common electrical signal format of the interface specific hardware circuit pack is then used to transport information received at its interfaces to one or more reconfigurable hardware circuit packs via the shared backplane assembly. The interface specific hardware circuit packs are designed to contain only the hardware and software required to transform the format of the signal received at its interfaces to that of the common electrical signal format. Therefore, the interface specific hardware circuit packs contain a minimal amount of hardware and software. The reconfigurable hardware circuit packs contain the reconfigurable hardware needed to process the information contained within the common electrical signal format. Typically, the reconfigurable hardware circuit packs will process the information contained within the common electrical signal format, and then send back resulting signals to one or more interface specific hardware circuit packs. A given reconfigurable hardware circuit pack can support many, if not all, interface specific hardware circuit packs. Therefore, a reconfigurable test unit can be completely morphed into different test boxes by simply replacing the interface specific hardware circuit packs and loading new hardware and software test entities into its reconfigurable hardware circuit packs.

According to a fifth embodiment of the present invention, the hardware and software test entities needed to test or monitor a specific function may only be used for a limited period of time once they are loaded into a reconfigurable test unit. The useable time period of an individual test entity can be specified independently of any other test entities. Once this time period expires, the hardware and software test entities will no longer be operational. In this embodiment, it is assumed that the user of the reconfigurable test unit pays a predetermined fee in order to utilize the hardware and software test entities for a predetermined period of time. This allows the user of the reconfigurable test unit to only pay for the hardware and software test entities when they are actually being used. In effect, the user of the reconfigurable test unit “rents” the software and hardware test entities.

### DETAILED DESCRIPTION OF THE INVENTION

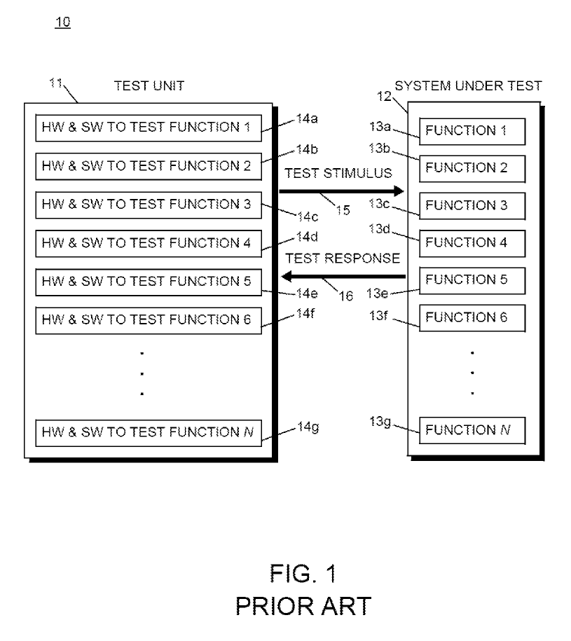

FIG. 1 shows a prior art test configuration 10. The test unit 11 is used to test a system under test 12 containing N functions 13a-13g. The test unit 11 simultaneously contains all the hardware (HW) and software (SW) 14a-14g needed to test all N functions within the system under test. This is accomplished by having the Test Unit 11 apply a Test Stimulus 15 to the System under Test 12, and then having the Test Unit 11 analyze or measure the Test Response 16 returned from the System under Test 12.

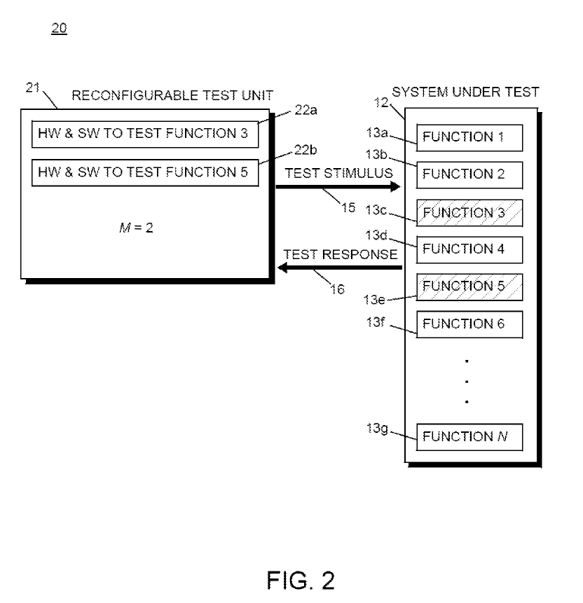

In contrast to FIG. 1, FIG. 2 shows a test configuration 20 in which only two of the N functions of the system under test 12 are tested (Function 3 and Function 5). In order to test the system, a reconfigurable test unit 21 is configured only with the necessary hardware and software needed to test Function 3 and Function 5. Therefore, for the example in FIG. 2, M is equal to 2 (i.e., M=2). In FIG. 2, the “HW & SW TO TEST FUNCTION 3” 22a is used to test “FUNCTION 3” 13c, and the “HW & SW TO TEST FUNCTION 5” 22b is used to test “FUNCTION 5” 13e. This is done by having the “HW & SW TO TEST FUNCTION 3” 22a generate a test stimulus 15 to “FUNCTION 3” 13c within the system under test 12, and then having the “HW & SW TO TEST FUNCTION 3” 22a analyze or measure the test response 16 from the system under test 12. In a similar manner, the “HW & SW TO TEST FUNCTION 5” 22b generates a test stimulus 15 to “FUNCTION 5” 13e within the system under test 12, and then the “HW & SW TO TEST FUNCTION 5” 22b analyzes or measures the test response 16 from the system under test 12. The “HW & SW TO TEST FUNCTION 5” may consist of both a hardware test entity and a software test entity. Together they are referred to as the test entity needed to test Function 5 within the system under test. Similarly the “HW & SW TO TEST FUNCTION 3” may consist of a hardware test entity and a software test entity. Together they are referred to as the test entity needed to test Function 5 within the system under test.

In some cases the test stimulus may simply be a request for information from the system under test. This type of testing is often referred to as test monitoring, or simply monitoring. For instance, the test unit may request the status of an alarm system. When prompted, the alarm system might return to the test unit information regarding the state of several residential entry points (doors, windows, etc.) at a particular residence. The test unit may then analyze the returned information in order to determine if an attempt was made to “break into” one of the entry points of the residence.

A system that is being tested or monitored may also send information back to the test unit without first being prompted to do so by the test unit. Such an exchange of information will be referred to as an “unprompted response”. For the case of an “unprompted response”, the system that is being tested or monitored 12 sends a “test response” 16 back to the test unit 21 without first receiving a “test stimulus” 15 from the test unit. Once an “unprompted response” is received from the system under test, it may be necessary for the test unit 21 to reconfigure itself based upon the information contained within the “unprompted response” in order to properly analyze or measure the information within the test response, or to analyze or measure future arriving information associated with the response. This type of test unit reconfiguration will be referred to as “unprompted response based reconfiguration”.

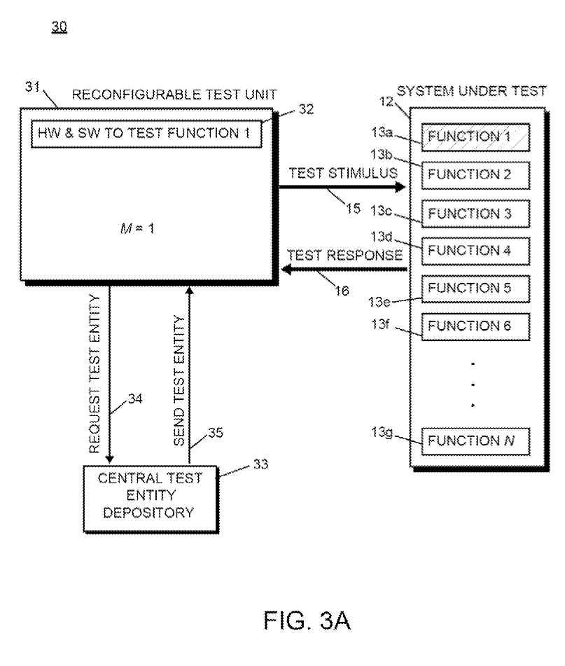

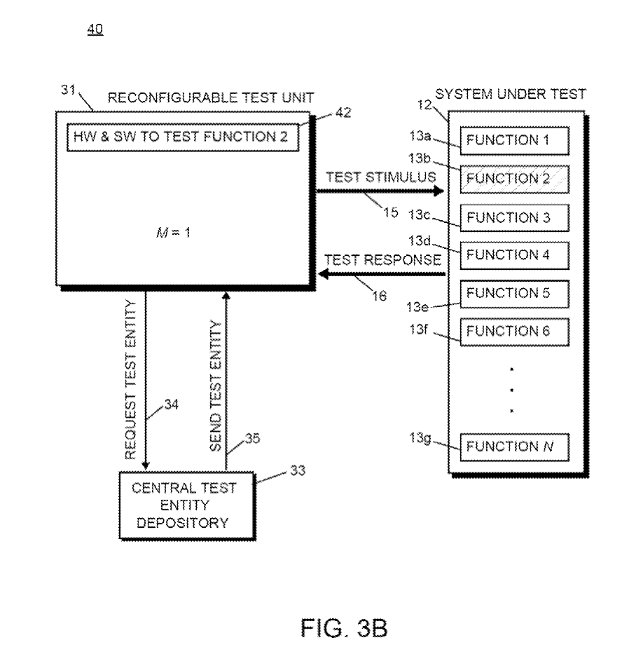

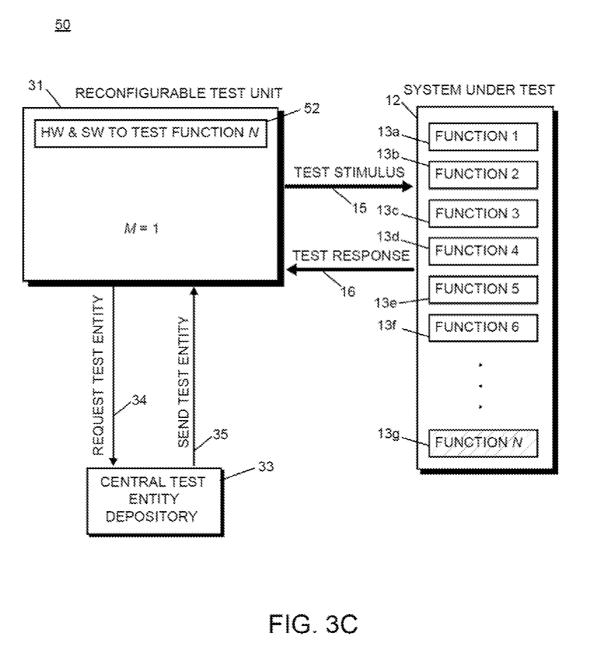

FIG. 3A-3C show a reconfigurable test unit 31 that is used to test all N functions 13a-13g of the system under test 12. In test configuration 30, the test unit 31 is first configured with the hardware (hardware test entity) and software (software test entity) needed to test Function 1 (i.e. the “HW & SW TO TEST FUNCTION 1”, 32). In order to perform this configuration, the appropriate hardware and software test entities must first be retrieved from either a local memory storage device (not shown) or a central test entity depository 33. “Function 1” 13a of the system under test 12 is then tested using the reconfigurable test unit 31. This is shown in FIG. 3A. Following the completion of the testing of “Function 1” 13a, in test configuration 40 the reconfigurable test unit 31 is reconfigured with the hardware (hardware test entity) and software (software test entity) needed to test Function 2 (i.e. the “HW & SW TO TEST FUNCTION 2”, 42) of the system under test 12. In order to perform this reconfiguration, the appropriate hardware and software test entities must first be retrieved from either a local memory storage device (not shown) or a central test entity depository 33. “Function 2” 13b of the system under test 12 is then tested using the reconfigurable test unit 31. This is shown in FIG. 3B. This process is repeated for the testing of “Function 3” 13c through Function N-1 (not shown). Following the completion of the testing of Function N-1 (not shown), in test configuration 50 the reconfigurable test unit 31 is reconfigured with the hardware (hardware test entity) and software (software test entity) needed to test Function N (i.e. the “HW & SW TO TEST FUNCTION N”, 52) of the system under test 12. In order to perform this reconfiguration, the appropriate hardware and software test entities must first be retrieved from either a local memory storage device (not shown) or a central test entity depository 33. “Function N” 13g of the system under test 12 is then tested using the reconfigurable test unit 31. This is shown in FIG. 3C. Following the completion of the testing of “Function N” 13g, all functions within the system under test 12 will have been tested.

In the example shown in FIG. 3, if the total amount of hardware needed to test all N functions within the system under test is equal to N, and the total amount of software needed to test all N functions within the system under test is equal to N, then the total amount of hardware needed within the reconfigurable test unit at any given time is equal to 1/N, and the total amount of software needed within the reconfigurable test unit at any given time is equal to 1/N. This assumes that the testing of each function requires hardware and software within the test unit that is independent from that needed to test all other functions within the system under test. This also assumes that each function within the system under test requires the same amount of hardware and software within the test unit. Since all functions within the system under test can be tested with the reconfigurable test unit using only 1/N of the hardware and software needed to test all N functions, substantial savings in the cost of hardware and software resources within the test unit can be realized by utilizing the test approach illustrated within the example of FIG. 3.

The reconfigurable hardware within the reconfigurable test unit may be implemented using field programmable gate arrays (FPGAs). (However, the reconfigurable hardware is not limited to field programmable gate arrays.) The FPGAs may be implemented using static RAM structures such as the FPGA families from Xilinx and Altera.

The reconfigurable hardware may be configured using a set of hardware configuration data. For this case, the hardware configuration data that is used to configure the hardware determines the hardware functions of the reconfigurable hardware. Therefore, reconfiguring the hardware with a different set of hardware configuration data changes the hardware functionality of the reconfigurable hardware. The hardware configuration data used to configure the reconfigurable hardware may be stored in a local memory storage device prior to being used to configure the reconfigurable hardware. This local memory may be located on the same circuit pack as the reconfigurable hardware, or it may be located on a second circuit pack which is connected to the circuit pack containing the reconfigurable hardware.

Alternatively, the hardware configuration data used configure the reconfigurable hardware may be located in a central test entity depository (33 in FIG. 3) that can be accessed by one or more test units. Prior to performing a test procedure, a given test unit may first retrieve the appropriate hardware configuration data from the central test entity depository, and then use this hardware configuration data to configure the reconfigurable hardware within the test unit. The retrieved hardware configuration data may either be used to directly reconfigure the reconfigurable hardware, or it may first be stored into a local reprogrammable memory unit within the test unit, and then later be used to reconfigure the reconfigurable hardware.

If a needed test entity is not contained within the reconfigurable test unit, then the test unit may retrieve the needed test entity from the central test depository. In order to retrieve a test entity from the central test entity depository, the reconfigurable test unit 31 first issues a “Request Test Entity” command 34 to the central test entity depository 33. The central test entity depository 33 then returns the requested test entity to the reconfigurable test unit 31 using a “Send Test Entity” reply 35.

The reconfigurable software resources are implemented using local reconfigurable memory, wherein this local reconfigurable memory is used to store sets of executable software coding instructions. The sets of executable software coding instructions (software entities) may be located in a central test entity depository (33 in FIG. 3) that can be accessed by one or more test units. Prior to performing a test procedure, a given test unit may first retrieve the appropriate set of executable software coding instructions (software entities) from the central test entity depository, and then use these coding instructions to configure the reconfigurable software within the test unit. The retrieved coding instructions may either be used to directly reconfigure the reconfigurable software, or they may first be stored into a local reprogrammable memory unit within the test unit, and then later be used to reconfigure the reconfigurable software.

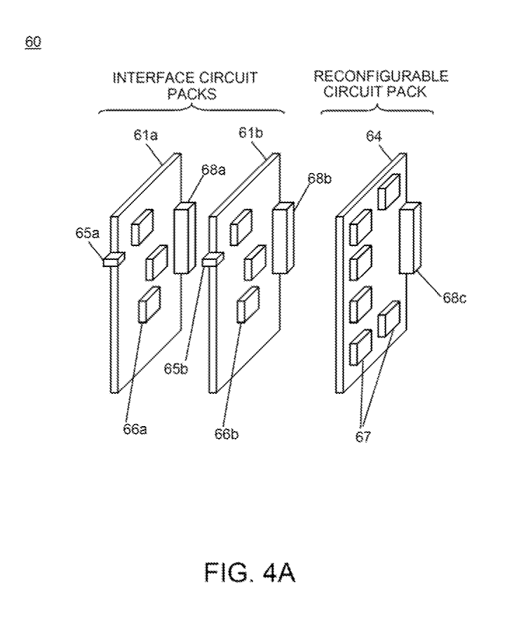

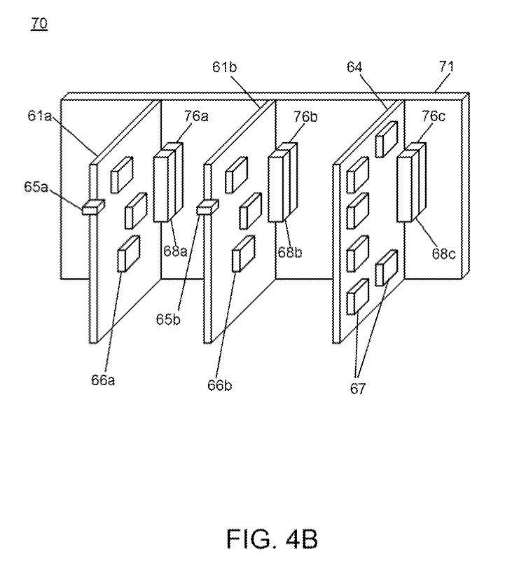

FIG. 4A shows a three dimensional view 60 of a reconfigurable hardware circuit pack 64 and two interface specific hardware circuit packs 61a-61b within one particular embodiment of a reconfigurable test unit. Each circuit pack contains a backplane assembly connector 68a-68c. The backplane assembly connector on a circuit pack is used to plug the circuit pack into a mating connector on the backplane assembly, as shown in FIG. 4B. The FIG. 4B configuration 70 shows three circuit packs 61a-61b, 64 plugged into a backplane assembly 71. The circuit packs exchange information by sending signals to and from their associated backplane assembly connectors 68a-68c via printed circuit board (PCB) traces residing on the backplane assembly. As shown in FIG. 4B, the backplane assembly connector 68a-68c on each circuit pack 61a-61b, 64 plugs into the corresponding backplane assembly connector 76a-76c on the backplane assembly 71.

As shown in FIG. 4A and FIG. 4B, the interface circuit packs 61a-61b additionally contain at least one format translation device 66a-66b and one or more front panel connectors 65a-65b. The front panel connectors 65a-65b allow external signals to enter and leave the interface circuit packs. These connectors typically are used to connect the reconfigurable test unit to a system under test. The input signals from the system under test enter the reconfigurable test unit via the front panel connectors 65a-65b on the interface circuit pack, and are then routed to the format translation devices 66a-66b via printed circuit board (PCB) traces on the interface circuit pack 61a-61b. The format translation devices 66a-66b then transform the externally received signals into the common electrical signal format. The common electrical signal format is then sent to the backplane assembly connector on the interface card 68a-68b via additional PCB traces on the interface circuit pack. From there, the signal is sent through the corresponding connectors 76a-76b on the backplane assembly. The electrical signals are then routed to the reconfigurable circuit pack 64 via PCB traces on the backplane assembly.

Signals arriving at a reconfigurable circuit pack 64 from the backplane assembly are routed from the backplane connector 68c to one or more reconfigurable hardware devices 67 on the reconfigurable circuit pack 64. The reconfigurable hardware devices 67 process the signals sent from the interface circuit packs 61a-61b, and then return any processed results to either one or more interface circuit packs 61a-61b or a system processor circuit pack (not shown in FIG. 4) via PCB traces on the backplane assembly.

The reconfigurable hardware devices 67 hold the reconfigurable hardware within the reconfigurable test unit. These devices can be reprogrammed to perform different hardware functions by loading into them different hardware test entities via the system processor circuit pack (not shown). In addition, the system processor circuit pack can be loaded with different software test entities via a suitable interface mechanism (such as a Local Area Network).

It can be noted that there may be a number of different types of interface circuit packs. For instance, there may be one type of interface circuit pack with optical connectors on its front panel, and another type of interface circuit pack with electrical connectors on its front panel. Similarly, there may be a number of different types of reconfigurable circuit packs. For instance, there may be one type of reconfigurable circuit pack with a small amount of reconfigurable hardware, and there may be another type of reconfigurable circuit pack with a large amount of reconfigurable hardware.

Although the pervious example showed two interface circuit packs connected to a single reconfigurable circuit pack, the invention is not limited to this configuration. In general, any number of interface circuit packs could connect to any number of reconfigurable circuit packs. For a fixed number of interface circuit packs, increasing the number of reconfigurable circuit packs allows an increasing amount of simultaneous reconfigurable functionality. In addition, there may be multiple types of reconfigurable circuit packs containing differing amounts of reconfigurable hardware and software resources.

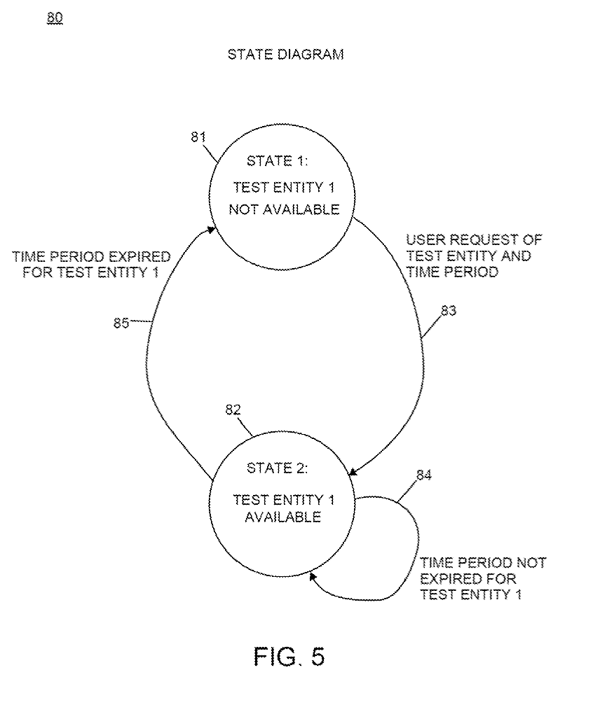

FIG. 5 shows the state diagram associated with the fifth embodiment of the invention. “State 1” 81 represents the state where test entity 1 is unavailable for use within the reconfigurable test unit. The user of the reconfigurable test unit must enable the test entity in order for it to be available for use. In order to enable the test entity, the user must request the test entity, and also request the time period for its use 83. Once this is done, the process moves to “State 2” 82, where test entity 1 is available for use. Test entity 1 will continue to be available for use until the time period expires. This is indicated by arc 84. Once the time period expires 85, the process moves back to “State 1” 81, where test entity 1 is unavailable.

When in State 1, the hardware and software entities associated with State 1 can either reside within the reconfigurable test unit and not be enabled, or they may reside outside of the reconfigurable test unit (at the central test entity depository, perhaps). If test entity 1 resides outside of the reconfigurable test unit, then prior to moving to State 2 the test entity must first be loaded into the reconfigurable test unit. This loading function may occur automatically after the request for the test entity is initiated.

There may be a fee associated with the request for a given test entity, or group of test entities. This fee may be added to the account associated with the requester of the test entity. The requester of the test entity may then be periodically billed for requested test entities. Alternatively, when the test entity is requested, the fee associated with a given test entity may be immediately deducted from the requester's credit card (or similar account) that is registered with the supplier of the test entity.

When a test entity is enabled within a given reconfigurable test unit, there are mechanisms in place within the test unit that keep track of the time period associated with the availability of the test entity. These mechanisms disable the use of the test entity once the time period associated with the test entity expires.

Alternatively, instead of being enabled for a specific period of time, a test entity could be enabled for a specific number of uses. For example, a test entity consisting of a pattern generator may be enabled to be used for ten (10) times.

Although, for purposes of illustration, the invention description utilizes examples of telecommunication test units and data test units, and residential alarm monitoring, the invention is not limited to only those applications. For instance, the invention can be applied to test units used in fields such as automotive, medical and other non-specified fields.

In the description above, for purposes of explanation, specific nomenclature is set forth to provide a thorough understanding of the embodiments of the present invention. However, it will be apparent to one skilled in the art that specific details in the description may not be required to practice the embodiments of the present invention. In other instances, well-known components are shown in block diagram form to avoid obscuring embodiments of the present invention unnecessarily.

In the foregoing specification, embodiments of the invention have been described with reference to specific exemplary embodiments thereof. It will, however, be evident that various modifications and changes may be made thereto without departing from the broader spirit and scope of the embodiments of the invention. The specification and drawings are, accordingly, to be regarded in an illustrative rather than restrictive sense.

While this invention has been particularly shown and described with references to preferred embodiments thereof, it will be understood by those skilled in the art that various changes in form and details may be made therein without departing from the scope of the invention.

What is claimed is:

1. A method for testing and monitoring systems wherein reconfigurable resources within a reconfigurable test unit are configured to test or monitor a first subset of the total set of functions associated with a given system under test, and
wherein the first subset may consist of any subset of the total set of functions associated with the system under test.

2. The method of claim 1 wherein following the completion of the testing or monitoring of a first subset of functions, the reconfigurable resources within the reconfigurable test unit are reconfigured in order to test or monitor a second subset of the total set of functions associated with the system under test, wherein the second subset of functions are substantially different than the first subset of functions.

3. The method of claim 2 wherein the first subset of functions consists of a single function and wherein the second subset of functions consists of a single function.

4. The method of claim 1 wherein the reconfigurable resources are reconfigurable hardware resources, and
wherein a set of hardware configuration data is used to configure the reconfigurable hardware resources.

5. The method of claim 4 wherein the set of hardware configuration data is stored in a local memory storage device prior to being used to configure the reconfigurable hardware resources.

6. The method of claim 4 wherein the set of hardware configuration data is stored in a central test entity depository prior to being used to configure the reconfigurable hardware resources.

7. The method of claim 4 wherein the reconfigurable hardware resources are implemented using field programmable gate arrays.

8. The method of claim 1 wherein the reconfigurable resources are reconfigurable hardware resources and reconfigurable software resources,
wherein a set of hardware configuration data is used to configure the reconfigurable hardware resources, and
wherein the reconfigurable software resources are configured with a set of executable software coding instructions.

9. The method of claim 8 wherein the set of hardware configuration data is stored in a local memory storage device prior to being used to configure the reconfigurable hardware resources, and
wherein the set of executable software coding instructions is stored in a local memory storage device prior to being used to configure the reconfigurable software resources.

10. The method of claim 8 wherein the set of hardware configuration data is stored in a central test entity depository prior to being used to configure the reconfigurable hardware resources, and
wherein the set of executable software coding instructions is stored in a central test entity depository prior to being used to configure the reconfigurable software resources.

11. The method of claim 1 wherein following the completion of the testing or monitoring of a first subset of functions, the reconfigurable resources within the reconfigurable test unit are reconfigured one or more additional times in order to test or monitor one or more additional subsets of the total set of functions associated with the system under test such that all functions within the system under test are tested.

12. The method of claim 8 wherein the set of hardware configuration data and the set of executable software coding instructions are prevented from being used after some predetermined amount of time, or after some predetermined number of uses.

13. An apparatus for testing and monitoring systems comprising of reconfigurable resources and being operative to test or monitor a first subset of functions of the total set of functions associated with a given system under test.

14. The apparatus of claim 13 wherein following the completion of the testing or monitoring of a first subset of functions, said reconfigurable resources being operative to being reconfigured in order to test or monitor a second subset of the total set of functions associated with the system under test, wherein the second subset of functions are substantially different than the first subset of functions.

15. The apparatus of claim 13 wherein the reconfigurable resources are comprised of reconfigurable hardware resources, and wherein the reconfigurable hardware resources are comprised of at least one field programmable gate array.

16. The apparatus of claim 13 wherein the reconfigurable resources are comprised of reconfigurable hardware resources and reconfigurable software resources,
wherein said reconfigurable hardware resources being operative to receive a set of hardware configuration data, and
wherein said reconfigurable software resources being operative to receive a set of executable software coding instructions.

17. The apparatus of claim 16 further comprising at least one local memory storage device, wherein the at least one local memory storage device holds said set of hardware configuration data prior to being used to configure the reconfigurable hardware resources, and
wherein the at least one local memory storage device holds said set of executable software coding instructions prior to being used to configure the reconfigurable software resources.

18. The apparatus of claim 16 further operative to retrieve a set of hardware configuration data and a set of executable software coding instructions from a central test entity depository, wherein the reconfigurable hardware resources are operative to receive said retrieved set of hardware configuration data, and wherein the reconfigurable software resources are operative to receive said retrieved set of executable software coding instructions.

19. The apparatus of claim 13 further comprising:
at least one reconfigurable hardware circuit pack, at least one interface specific hardware circuit pack, and a backplane assembly,
wherein the at least one reconfigurable hardware circuit pack contains said reconfigurable resources, and
wherein the at least one interface specific hardware circuit pack contains connectors used to connect the apparatus to a system under test, and
wherein the backplane assembly is used to pass signals between the at least one reconfigurable hardware circuit pack and the at least one interface specific hardware circuit pack.

20. An apparatus for testing and monitoring systems wherein the apparatus contains reconfigurable resources, and
wherein the reconfigurable resources are operative to being newly reconfigured based upon the information contained within an unprompted response from a system under test, and
wherein the said newly reconfigured resources are operative to test, measure, or monitor system functions relating to the information contained within the unprompted response.
